(19) United States
(12) Patent Application Publication
(10) Pub. No.: US 2006/0107876 A1
(43) Pub. Date: May 25, 2006

(54) Glycol-functional siloxane mixture

(75) Inventors: Frank Sandmeyer, Burgkirchen (DE); Georg Loessel, Emmerting (DE); Dieter Gerhardinger, Massing (DE)

Correspondence Address: BROOKS KUSHMAN P.C., 1000 TOWN CENTER, TWENTY-SECOND FLOOR, SOUTHFIELD, MI, 48075, US

(73) Assignee: Wacker-Chemie GmbH, Munich (DE)

(21) Appl. No.: 11/282,143

(22) Filed: Nov. 18, 2005

(30) Foreign Application Priority Data
Nov. 25, 2004 (DE) 10 2004 056 977.0

(51) Int. Cl. C04B 28/14; C04B 11/00

(52) U.S. Cl. 106/772

(57) ABSTRACT

Water-repellent gypsum compositions of components (A) 100 parts by weight of gypsum (B) 0.05-50 parts by weight of oxide and/or hydroxide or alkali and/or alkaline earth metals (C) 0.05-20 parts by weight of glycol-functional siloxane mixture, preparable by the reaction of 1 mole of alkyltrihalosilane or alkyltrialkoxysilane with at least 2.5 moles of a glycol or mixture of glycols, exhibit water repellancy similar to gypsum which has been hydrophobed with H-siloxane.

### BACKGROUND OF THE INVENTION

1. Field of the Invention

The invention relates to a water-repellent gypsum composition, to a process for the water-repellent treatment of gypsum, to a glycol-functional siloxane mixture, and to its preparation.

2. Background Art

Water-repellent properties can be imparted to gypsum by treatment with organosiloxanes containing Si-bonded hydrogen atoms (H-siloxanes). The water-repellent effect of H-siloxanes can be improved by adding alkaline compounds, such as siliconates or calcium hydroxide. For example, U.S. Pat. No. 5,624,481 describes the improvement of the water-repellent impregnation of H-siloxanes by addition of alkali metal silicate. Such alkaline compounds promote the formation of organosilicon cleavage products from H-siloxanes in the presence of gypsum. DE 1 076 946 discloses the imparting of water repellency to glass fibers and masonry with glycol-functional siloxanes, but not to gypsum.

WO 99/50200 describes the reduction of the water absorption of gypsum by treatment with a H-siloxane and a hydrocolloid which comprises an optionally derivatized galactomannan.

WO 99/50201 describes the reduction of the water absorption of gypsum with H-siloxanes and a hydrocolloid which comprises an optionally derivatized galactomannan, additionally containing a polysaccharide. For the industrial production of light gypsum moldings, gypsum slurry containing the water-repellent additives is expanded by incorporating air to give a gypsum foam which rapidly sets. This foam disintegrates rapidly by the action of galactomannan.

The principle raw material for the preparation of H-siloxane is methyldichlorosilane (CH₃Si(Cl)₂H). This silane is obtained as a byproduct from the Rochow synthesis of chlorosilanes, it not being possible to increase the yields of this silane arbitrarily. The total world production of methyldichlorosilane is not sufficient to cover the demand for H-siloxane preparable therefrom for hydrophobing gypsum.

DE 1 076 946 teaches that organopolysiloxanes which are suitable for imparting water-repellent properties to porous and solid bodies are obtained from the reaction products of alkylalkoxysilanes with ethylene glycol. The alkylalkoxysilanes are a mixture of monoalkoxy-, dialkoxy-, trialkoxy- and tetraalkoxysilanes, it also being possible to use only a trialkoxysilane. The trialkoxysilane or the alkoxysilane mixture is reacted with ethylene glycol, at least one hydroxyl group of the ethylene glycol being in excess per silicon-bonded alkoxy group. As a result, one molecule of ethylene glycol is used per alkoxy group. However, the reference indicates that desirable properties of the product such as shelf life in the undiluted state, water solubility, and hydrophobing power, can be achieved only by complying with the ratios described. As a result of the synthesis process, up to 5% of silicon-bonded alkoxy groups which have not reacted with ethylene glycol are present in the end product. Also present in the end product are radicals of alcohol eliminated during the condensation which cannot be completely removed. The synthesis requires an exact temperature regimen in which it is ensured that the reaction temperature does not exceed 100° C. The hydrophobing effect of the product is obtained only if a sufficient amount of water is added. However, the stability of the products is reduced by the addition of water.

GB 2 355 453 A describes the hydrophobic coating of calcium carbonate with H-siloxane or H-siloxane emulsions, H-siloxanes used here being those which comprise cyclic H-siloxanes. The hydrophobically coated calcium carbonates are intended for use as a filler in synthetic elastomers or coatings.

U.S. Pat. No. 2,887,467 describes the synthesis of water-soluble silsesquioxanes by reaction of water-insoluble silsesquioxanes with ethylene glycol at temperatures of about 150° C., it being necessary for at least 3 equivalents of ethylene glycol to be present per silicon atom. The products thus obtained are in principle suitable for use as water repellents.

### SUMMARY OF THE INVENTION

It is an object of the invention to improve the prior art, in particular to provide water-repellent gypsum compositions, and to develop an efficient silicon-based alternative to H-siloxane for hydrophobing which can be prepared in such large amounts that the world demand for silicon-based water repellents, in particular for the water-repellent treatment of gypsum, can be satisfied. These and other objects are achieved by the invention.

### DETAILED DESCRIPTION OF THE PREFERRED EMBODIMENT(S)

The invention relates to a water-repellent gypsum composition comprising the components:
(A) 100 parts by weight of gypsum
(B) 0.05-50 parts by weight of oxide and/or hydroxide of alkali and/or alkaline earth metals
(C) 0.05-20 parts by weight of glycol-functional siloxane mixture, preparable by the reaction of 1 mole of alkyltrihalosilane or alkyltrialkoxysilane with at least 2.5 moles of a glycol or mixture of glycols.

The water-repellent gypsum composition may be present, for example, in powder form or as moldings.

The water-repellent gypsum composition may contain any type of gypsum. Among the types of gypsum, plasters (CaSO₄.H₂O) in the form of, for example, building plaster, plaster of Paris or insulating plaster and natural gypsum (CaSO₄.0.5H₂O) are preferred. Other types of gypsum, such as estrich plaster, imitation marble and anhydrite, can also be used. The calcium sulfate obtained in stack gas desulfurization is also suitable.

CaO, MgO, Ca(OH)₂, Mg(OH)₂ and NaOH are preferred as an oxide and/or hydroxide of alkali and/or alkaline earth metals (B), in particular Ca(OH)₂, CaO and NaOH. Preferably from 0.05 to 50 parts by weight, in particular from 0.1 to 30 parts by weight, based on 100 parts by weight of gypsum (A), of oxide and/or hydroxide (B) are used.

The glycol-functional siloxane mixture (C) contains silanes, oils or resins or any desired mixture thereof and is composed of units of the general formula 1 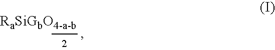
in which
R is a monovalent, optionally halogen-substituted C₁-C₁₅-hydrocarbon radical or monovalent hydrocarbonoxy radical, or a hydroxyl group,
a is 0, 1, 2 or 3 and has a minimum value of 0.1 on average,
b is 0, 1, 2 or 3 and has a minimum value of 0.1 on average,
G is an oxygen atom, a hydroxyl radical or a monovalent or divalent branched or linear C₁-C₂₅-glycol radical, the glycol-functional siloxanes preferably being obtained from a reaction of methyltrialkoxysilane or methyltrihalosilane with a branched or linear C₁-C₂₅-glycol, with the proviso that glycol radicals are contained in a number such that the molecule is water-soluble or self-emulsifying, the stoichiometry of the reaction being chosen so that 2.0-2.99 moles of the respective glycol are used per mole of methyltrichlorosilane or methyltrimethoxysilane.

The invention furthermore relates to a glycol-functional siloxane mixture, which can be prepared by reacting one mole of alkyltrihalosilane or alkyltrialkoxysilane with, preferably, from 2.5 to 2.9, more preferably 2.5-2.8, and most preferably 2.8 moles of a glycol or mixture of glycols.

Surprisingly, it was found that the same water-repellent effect as with H-siloxane can be achieved with glycol-functional siloxanes, in particular gypsum-hydrophobing glycol-functional siloxane mixtures. Contrary to DE 1 076 946, it was found that by reacting one mole of methyltrichlorosilane or methyltrimethoxysilane with less than 3 moles of ethylene glycol, stable, very readily hydrophobing products are obtained. Using the example of gypsum hydrophobing, it was found that the novel glycol-functional siloxanes according to the invention are even more efficient than the ethylene glycol-functional siloxanes of DE 1 076 946.

Glycol-functional siloxane mixtures according to the invention are obtained, for example, by reacting an alkyltrihalosilane, preferably methyltrichlorosilane, with a glycol such as ethylene glycol, the molar ratios preferably being chosen so that in each case 1 mole of methyltrichlorosilane is reacted with from 2.0 to 2.9 moles of ethylene glycol.

The glycol-functional siloxane mixtures are also obtained if an alkyltrimethoxysilane is used instead of alkyltrichlorosilane, methyltrimethoxysilane being particularly suitable. The reaction rate may be accelerated to completion by varying the pH. The reaction is complete when only less than 5% of the alkoxy groups originally present on the methyltrialkoxysilane are present. Instead of the preferred ethylene glycol, it is also possible to use other glycols, such as diethylene glycol, propylene glycol, dipropylene glycol, etc., or mixtures thereof.

The glycol-functional siloxane mixture according to the invention contains silanes, oils or resins or any desired mixture thereof, these being composed of units of the general formula 1 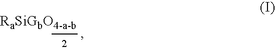
in which
R is a monovalent, optionally halogen-substituted C₁-C₁₅-hydrocarbon radical, monovalent hydrocarbonoxy radical, or hydroxyl group,
b is 0, 1, 2 or 3 and has a minimum value of 0.1 on average,
G is an oxygen atom, a hydroxyl radical or a monovalent or divalent branched or linear C₁-C₂₅-glycol radical, with the proviso that glycol radicals are contained in a number such that the molecule is water-soluble or self-emulsifying, the glycol-functional siloxanes according to the invention being characterized in particular in that they are obtained from a reaction of methyltrialkoxysilane or methyltrihalosilane with a branched or linear C₁-C₂₅-glycol, the stoichiometry of the reaction being chosen so that 2.0-2.99 moles of the respective glycol are used per mole of methyltrichlorosilane or methyltrimethoxysilane.

Examples of the C₁-C₁₅-hydrocarbon radicals are alkyl radicals such as the methyl, ethyl, n-propyl, isopropyl, n-butyl, isobutyl, tert-butyl, n-pentyl, isopentyl, neopentyl, and tert-pentyl radicals; hexyl radicals such as the n-hexyl radical; heptyl radicals such as the n-heptyl radical; octyl radicals such as the n-octyl radical and isooctyl radicals such as the 2,2,4-trimethylpentyl radical; nonyl radicals such as the n-nonyl radical; decyl radicals such as the n-decyl radical; dodecyl radicals such as the n-dodecyl radical; alkenyl radicals such as the vinyl and the allyl radical; cycloalkyl radicals such as the cyclopentyl, cyclohexyl, cycloheptyl, and methylcyclohexyl radicals; aryl radicals such as the phenyl, naphthyl, anthryl and phenanthryl radicals; alkaryl radicals such as the o-, m- and p-tolyl radicals, xylyl radicals and ethylphenyl radicals, and aralkyl radicals such as the benzyl radical and the α- and the β-phenylethyl radicals.

Examples of halogen-substituted C₁-C₁₅-hydrocarbon radicals are alkyl radicals substituted by fluorine, chlorine, bromine and iodine atoms, such as the 3,3,3-trifluoro-n-propyl radical, the 2,2,2,2′,2′,2′-hexafluoroisopropyl radical and the heptafluoroisopropyl radical, and haloaryl radicals such as the o-, m- and p-chlorophenyl radicals.

The unsubstituted C₁-C₆-alkyl radicals are most preferable, in particular the methyl radical and the ethyl radical.

Examples of C₁-C₁₅-hydrocarbonoxy radicals are the above C₁-C₁₅-hydrocarbon radicals which are bonded to the silicon atom via a divalent oxygen atom. Preferably, not more than 5% of the radicals R are hydrocarbonoxy radicals.

Examples of branched or linear C₁-C₂₅-glycol radicals are α,ω-dihydroxy-functional glycols, preferably ethylene glycol, propylene glycol, di-, tri- and tetraethylene glycol, di-, tri- and tetrapropylene glycol, α,ω-dihydroxy-functional mixed glycols comprising 1 to 5 ethylene glycol units and 1 to 5 propylene glycol units and mixtures thereof, most preferably, ethylene glycol.

The glycol-functional siloxane mixtures preferably have a viscosity of not more than 5000 mm²/s, in particular from 5 to 1000 mm²/s, at 25° C.

If G is a monovalent glycol radical, it is preferably hydroxyl-terminated. If G is a divalent glycol radical, it bridges two silicon atoms.

In addition to the starting materials which form the glycol-functional siloxane mixtures, other auxiliaries such as solvents and catalysts are optionally present in the reaction. When choosing a solvent, it should be ensured in particular that the solvent does not undergo secondary reactions with the optionally used alkyltrihalosilane. Typical and suitable solvents are aromatic and aliphatic hydrocarbons such as toluene, xylene and ethylbenzene, and aromatics-containing or aromatics-free aliphatic mixtures, preferably having a boiling range of <180° C.

Particularly with the use of methyltrimethoxysilane, the addition of pH-reducing or pH-increasing compounds may be advantageous for accelerating and completing the reaction. Typical and suitable catalysts are p-toluenesulfonic acid, or bases such as alkali metal siliconates. Residual amounts of HCl or silicon-bonded chlorine are optionally present in the end product and give a total residual chlorine content which is usually in the range of less than 100 ppm but may also be substantially lower or higher. This property can be controlled by establishing suitable parameters during synthesis, product isolation and purification. Typical measures in this respect during the synthesis are, for example, prolonging the reaction time, increasing the reaction temperature and adding small amounts of reactive monomers such as alcohols, water or other substances such as basic alkali metal or alkaline earth metal salts or amines which are reactive toward silicon-bonded chlorine and which can react with the radical on silicon-bonded chlorine.

If a gas stream (e.g. nitrogen gas) is passed through the reaction vessel during the synthesis, the resulting HCl is thus also expelled. It is moreover helpful to apply a slight vacuum to the apparatus during the synthesis in order to promote the discharge of HCl from the reaction mixture. Such measures can be operated, in each case, individually or in combination.

Typical measures for controlling the residual Cl content (this includes the residual HCl content) during product isolation are, for example, applying a vacuum or washing to neutrality with water with which substances are optionally mixed which establish a basic pH, for example, sodium carbonate, sodium hydroxide, etc., or water-soluble or water-dispersible organic compounds or water-soluble or water-dispersible organic salts.

The invention furthermore relates to a process for the preparation of a glycol-functional siloxane mixture, wherein one mole of an alkyltrihalosilane or alkyltrialkoxysilane is reacted with, preferably, from 2.5 to 2.9, more preferably 2.5-2.8, and most preferably 2.8, moles of a glycol or mixture of glycols, preferably ethylene glycol or propylene glycol.

The glycol-functional siloxanes can be prepared both in a batchwise process and in a continuous process. Combinations of continuous and batchwise steps are also suitable. In its essentials, the process for the preparation of glycol-functional siloxanes generally comprises the steps of metering, condensation and solvent evaporation, or the steps of metering and condensation. Further optional steps which may be necessary in some cases, are neutralization, filtration and stabilization.

If an alkyltrihalosilane such as methyltrichlorosilane is reacted with a glycol such as ethylene glycol, the trihalosilane is preferably added to the glycol, the stoichiometry specified above being established. Preferably, the alkyltrihalosilane or alkyltrialkoxysilane is metered in from beneath the glycol or mixture of glycols, not added dropwise onto the surface. The glycol can optionally be diluted by adding a solvent, or a solvent may be added to the silane and the solvent-silane mixture metered into the glycol. Solvents which may be suitable are those which react neither with chlorosilanes nor with glycols; with which the glycol used or the chlorosilane can be mixed to give a clear and homogeneous mixture; and which have a boiling point of at least 80° C. It is not necessary for the solvent to provide a clear homogeneous mixture both with the glycol and with the chlorosilane. Likewise, it is not necessary for the solvent to dissolve the product from the reaction to give a clear and homogeneous solution. Multiphase character (a plurality of liquid phases) is permissible in the reaction or the working up of the product, although it is not required.

The metering can be effected technically in various ways and depends in detail on the respective plant geometry and plant technology. Suitable plant geometries and plant and process technologies are in principle all those suitable for the condensation reactions with chlorosilanes. These are, for example, those which are used for the continuous or batchwise preparation of silicone resins, i.e. acid-resistant stirred reactors, stirred cascades or loop or column units.

Examples of typical and preferred plant configurations include those in which the total reaction takes place in a stirred reactor, or those in which two or three stirred reactors are connected so that a part of the reaction takes place in one stirred reactor, such as, for example, the metering and the partial alkoxylation of the silane with the glycol or glycol mixture, and other parts of the reaction take place in the other stirred reactor or the other stirred reactors, such as, for example, the complete alkoxylation of the silane with the glycol or glycol mixture or a subsequent condensation reaction and optionally the distilling off of the optionally used solvent for product isolation. Instead of by distillation from the stirred reactor, the distillative removal of the optionally present solvent or of volatile components formed during the reaction can also be effected by evaporation of the respective volatile components by using a thin-film evaporator or a falling-film evaporator or similar apparatuses as usually used for such manipulations.

Further useful configurations include those in which a loop is connected to at least one stirred reactor, the product mixing and partial reaction being initially effected in a loop reactor and the completion of the reaction being effected in the downstream stirred reactor and the distillative removal of the optionally present solvent or of volatile components formed in the reaction being effected by evaporation of the optionally used solvent or of the volatile components which may be formed during the reaction by using a thin-film evaporator or a falling-film evaporator or similar apparatuses as usually used for such manipulations.

Another configuration is one in which two loop reactors are connected to one another so that a part of the reaction is effected in one loop and the reaction is completed in a second loop reactor, and the distillative removal of the optionally present solvent or of volatile components formed in the reaction is effected by evaporation of the optionally used solvent or of the volatile components which may be formed during the reaction by using a thin-film evaporator or a falling-film evaporator or similar apparatuses as usually used for such manipulations.

A yet further configuration is one in which a part of the reaction is effected in a column unit, such as, for example, the synthesis of an alkyltrialkoxysilane from an alkyltrihalosilane, the reaction is then effected in one or more downstream stirred reactors or combinations of a loop reactor with a further loop reactor or at least one stirred reactor, as already described above, and the distillative removal of the optionally present solvent or of volatile components formed in the reaction is effected by evaporation of the optionally used solvent or of the volatile components which may be formed during the reaction by using a thin-film evaporator or a falling-film evaporator or similar apparatuses as usually used for such manipulations.

The synthesis of the glycol-functional siloxanes according to the invention can also be effected starting from alkyltrialkoxysilanes such as methyltrimethoxysilane, instead of from trihalosilanes. The metering can be effected in the same manner as was described for the trihalosilanes. Owing to the substantially lower reactivity of the alkoxysilanes, it is helpful to add a catalyst in order to enable the reaction to reach the desired conversion more rapidly. Such a catalyst may be, for example, an acid such as hydrochloric acid or para-toluenesulfonic acid. In principle, the reaction can also be effected without catalysis but then requires longer reaction times and may require higher temperatures. With the use of alkyltrialkoxysilanes, the addition of water to the reaction may be necessary or advantageous.

The reaction starting from halosilanes such as trichloro- or tribromosilanes, in particular from trichlorosilanes, is preferred, and methyltrichlorosilane is the preferred starting material. After the end of the addition, the reaction mixture is heated to complete the reaction, the temperature preferably being from 80 to 150° C.

The hydrogen chloride gas formed is either expelled by a gas stream (for example, nitrogen) or removed from the reaction mixture by applying a vacuum. It is also feasible to use a combination of gas stream and vacuum in order to expel the HCl gas. The reaction mixture thus obtained can be worked up immediately, as described further below, and this can easily lead to a slightly turbid product, which however is not impaired in its efficiency and stability. However, the reaction mixture can also be subjected to a neutralization step before the further working-up, in order to reliably obtain a completely clear product. The neutralization is effected by adding pH-reducing substances, for example, inorganic salts such as sodium bicarbonate or an alkali metal hydroxide. Solids can be separated off from the mixture after the neutralization by suitable measures for separating solids, such as filtration, centrifuging, pressing off, etc.

In order to increase shelf life, a small amount of a basic compound may be added to the product solution obtained. The storage stabilizer is chosen so that it is soluble in the product to give a clear solution when used in an amount of a few tenths of a percent. Such stabilizers may be, for example, amine compounds.

Optionally used solvents are subsequently evaporated, known methods according to the prior art being used, for example, distilling under atmospheric pressure or under reduced pressure, or evaporation in a thin-film evaporator.

The invention also relates to a process for the water-repellent treatment of gypsum, in which
(A) 100 parts by weight of gypsum are mixed with
(B) 0.05-50 parts by weight of oxide and/or hydroxide of alkali and/or alkaline earth metals and
(C) 0.05-20 parts by weight of glycol-functional siloxane mixture which can be prepared by reacting 1 mole of alkyltrihalosilane or alkyltrialkoxysilane with at least 2.5 moles of a glycol or mixture of glycols.

In the process for the hydrophobing (water-repellent treatment) of gypsum, gypsum, for example in powder form or as moldings, can be treated with glycol-functional siloxanes or a formulation thereof.

The glycol-functional siloxanes can be used for gypsum hydrophobing with known action-enhancing additives, such as those which, for example, are also effective for enhancing the action of H-siloxane, i.e. for example with starch ethers, or with basic additives such as cement and further additives as listed further below.

The glycol-functional siloxanes according to the invention can be used in the form of pure substances or can be used for the preparation of formulations. Formulations are, for example, aqueous formulations comprising at least one glycol-functional siloxane and water, milky turbid liquids being thus obtained. For the preparation of an aqueous formulation from water and a glycol-functional siloxane, the addition of a further emulsifier may be required. In the case of self-emulsifying glycol-functional siloxanes, this is not required. In addition, further substances can optionally be used in such aqueous formulations, for example those as stated below.

Aqueous, nonaqueous, or solvent-based formulations are obtained by combining the glycol-functional siloxanes with other components, these combinations not necessarily giving homogeneous mixtures.

Examples of possible components for combining are H-siloxane; alkoxy- and aryloxysilanes which may additionally have organofunctional radicals or alkyl or aryl radicals; alkyl or arylsiliconates; polydimethylsiloxane oils which, instead of one or more methyl groups, may optionally carry other organic groups, such as hydrocarbon radicals other than methyl radicals, it being possible for the hydrocarbon chain to be interrupted in these hydrocarbon radicals by the incorporation of hetero atoms, such as S, N, O, P, etc., or for organic functionalities also to be contained; starch ethers; silicone resins; one or more organic solvents, such as aromatic solvents, ketones, esters, alcohols, aliphatic and cycloaliphatic solvents, ionic liquids, glycols, etc.; water; organic surfactants; organic polymers, such as polyvinyl alcohol, polyvinyl acetate, polyacrylates, styrene/acrylate copolymers, polyvinyl butyrals, polyurethanes, polyepoxides, etc.; linear and branched, optionally organically functionalized polyhydroxylated hydrocarbons, such as ethylene glycol, diethylene glycol, propylene glycol, dipropylene glycol and higher glycols, sugars, such as glycoses, mannoses, hexoses, etc.; cement; lime; and gypsum, or combinations of these components. It is not absolutely essential that the components to be mixed permit processing to give a homogeneous uniform mixture of active ingredients.

The invention also relates to processes for the hydrophobing of moldings, a glycol-functional siloxane mixture being used for this purpose.

The glycol-functional siloxanes are preferably used in the form of an aqueous formulation, in the form of an emulsion, or in the form of an aqueous foam. For the preparation of aqueous formulations, surfactants may be used or they may be prepared without addition of surfactants, by introducing the glycol-functional siloxanes directly into water. The preparation of aqueous formulations without the use of surfactants is possible in particular when the glycol-functional siloxanes according to the invention are self-emulsifying in water or water-soluble.

Among the types of gypsum, plaster (CaSO₄.0.5H₂O) in the form of building plaster, plaster of Paris, or insulating plaster is preferred. Other types of gypsum, such as estrich plaster, imitation marble, anhydrite and the calcium sulfate obtained in stack gas desulfurization, are also suitable. The gypsum may contain additives which facilitate the production of gypsum moldings or improve the properties of the gypsum moldings. Additives are, for example, Portland cement or white cement, fillers such as silica and cellulose fibers, accelerators such as potassium sulfate and aluminum sulfate, retardants such as proteins or tartaric acid salts, plasticizers for the gypsum slurry such as ligninsulfonates, and adhesion promoters for cardboard such as starch.

Preferably from 0.02 to 40, more preferably from 0.1 to 8, and most preferably from 0.5 to 4, parts by weight of the glycol-functional siloxanes, based on 100 parts by weight of gypsum, are used.

If the gypsum composition is processed to give a moldable material, water must be added. Preferably from 30 to 120, in particular from 50 to 90, parts by weight of water, based on 100 parts by weight of gypsum, are added. The gypsum composition can be prepared in any desired manner. The glycol-functional siloxanes can be added to the gypsum composition in pure form or as an aqueous formulation or emulsion.

For the production of gypsum moldings, the gypsum composition which contains the glycol-functional siloxanes and a small amount of cement, preferably 0.5 percent by weight, and water is processed to give a gypsum slurry. This gypsum slurry can also be expanded by incorporating air to give a gypsum foam. The invention also relates to compositions which contain the glycol-functional siloxanes and gypsum, and moldings which comprise this composition.

The gypsum moldings which contain the glycol-functional siloxanes are further aspects of the invention. The gypsum moldings can be produced by molding a gypsum composition which contains water and the glycol-functional siloxanes. They can also be produced by impregnating a gypsum molding with the glycol-functional siloxanes or a formulation which contains said siloxanes, after molding, after setting, or not until after drying. The impregnation can be effected, for example, by immersion, spraying, or coating with the glycol-functional siloxanes or a formulation which contains these. Examples of gypsum moldings are gypsum boards such as wall construction boards or sandwich-type plasterboards.

### PREPARATION EXAMPLES

Batchwise synthesis of glycol-functional siloxanes.

Apparatus:

2 l three-necked flask with jacketed coil condenser, dropping funnel and paddle stirrer. Gas discharge and the application of vacuum are effected via the jacketed coil condenser.

General Procedure:

Methyltrichlorosilane is mixed with toluene in the ratio 1:1 and metered into an initially present 2.8-fold molar excess of ethylene glycol by means of a dropping funnel. A slight water jet vacuum is continuously applied to the apparatus (about 200 mbar).

### Example 1a

Ethylene glycol (550.0 g) is initially introduced into a closed stirred three-necked flask. A mixture of 473.10 g of methyltrichlorosilane and 473.10 g of toluene is introduced into the dropping funnel. The mixture of methyltrichlorosilane and toluene is metered from the dropping funnel to below the surface of the initially introduced ethylene glycol. The temperature is kept at from 50° C. to 55° C. by means of the metering rate. The duration of metering is about 70 minutes.

After the methyltrichlorosilane/toluene mixture has been completely metered in, the system is kept under reflux for 2 hours. After the refluxing, the batch is cooled to room temperature. Two phases form, one phase being toluene and the second phase being the product phase which contains polyether-modified polysiloxane. The HCl content of the crude product is <50 ppm. The phases are separated, and the toluene is distilled from the product phase by means of a rotary evaporator in vacuo (about 10 mbar, 110° C.).

### Example 2

Ethylene glycol (550.0 g) is initially introduced into a closed stirred three-necked flask. 473.10 g of methyltrichlorosilane is introduced into the dropping funnel. Methyltrichlorosilane is metered from the dropping funnel to below the surface of the initially introduced ethylene glycol. The temperature is kept at from 50° C. to 55° C. by means of the metering rate. The duration of metering is about 70 minutes. After the methyltrichlorosilane has been completely metered in, the system is kept at 100-120° C. for 2 hours. The batch is then cooled to room temperature. The HCl content of the crude product is <50 ppm.

Continuous Synthesis Employing a Stirred Vessel Cascade.

Apparatus:

1 1000 ml glass reactor (=reactor 1) heatable by means of a double jacket; two feeds; a reflux condenser, temperature measurement means, and stirrer. 1 1000 ml three-necked flask (=reactor 2) with reflux condenser, temperature measuring means, stirrer, and heating mantle. Reactors 1 and 2 are connected to an overflow system which, together with the suitable product outflow, makes it possible to maintain a constant degree of filling of 600-700 ml in the two reactors, and product transport from reactor 1 to reactor 2. Gas discharge and optional application of vacuum are effected via the reflux condenser. The apparatus further contains 1 product-collecting vessel (1000 ml beaker), and two metering pumps.

General Procedure:

Reactors 1 and 2 are filled with product from the batch reaction of M1-silane and E-glycol (cf. synthesis examples for batch reaction) to a degree of filling of 60-70% (=600-700 ml). The product outflow from reactor 1 to reactor 2 is likewise filled with product. Methyltrichlorosilane and ethylene glycol are then added in the molar ratio 1:2.8, and the end product is discharged from reactor 2 into the product-collecting container so that a residence time of 2 h results and the initially established levels of fill remain constant at 60-70%.

### Example 3

151 ml/h of methyltrichlorosilane and 197 ml/h of ethylene glycol are introduced via two independent metering pumps into the stirred reactor 1. The internal temperature of the reactor 1 is optionally kept at 50-60° C. by means of heating. The crude product flowing from reactor 1 via the overflow into reactor 2 is brought to an internal temperature of 120° C. by means of a heating mantle, likewise with continuous stirring, with the result that the reaction takes place completely within two hours. The HCl formed in this continuous reaction cascade is removed continuously via the reflux condenser by using nitrogen as stripping gas. The resulting product has a residual HCl content of <150 ppm.

### USE EXAMPLES

In the following use examples for gypsum hydrophobing, all stated parts and percentages are based on weight. The examples were carried out at a pressure of the surrounding atmosphere, i.e. about 0.1 MPa, and at room temperature, i.e. about 21° C. The viscosities were measured at 25° C.

### Example 4

### Water Absorption

Production of the Test Specimens

A gypsum slurry was prepared from 100 parts by weight of natural gypsum (CaSO₄.0.5H₂O), 70 parts by weight of water and optionally further parts by weight of additive, and was poured into molds to give disk-like test specimens having a diameter of 8 cm and a height of 2 cm. After 30 minutes, the solidified test specimens were removed from the molds. The test specimens were dried first for 24 hours at 40° C. and then for 3 days at 20° C.

Water Absorption According to DIN 18180

The test specimens were immersed in the horizontal position in water at 23° C. so that a 2 cm water column stood above the sample surface. After storage in water for two hours, the test specimens were removed from the water, the water adhering to the surface was removed and the increase in mass was determined by weighing. The results may be summarized as follows:
a) (not according to the invention) Gypsum without additives had a water absorption of 40.67% by weight.
b) (according to the invention) The following was added as an additive to the gypsum slurry: 1.0% of a glycol-functional siloxane from example 1, and 0.5% by weight of Portland cement. The gypsum had a water absorption of 2.5% by weight.
c) (according to the invention) The following were added as additives to the gypsum slurry: 0.5% by weight of a glycol-functional siloxane from example 1, and 0.5% of Portland cement. The gypsum had a water absorption of 3.03% by weight.
d) The following were added as additives to the gypsum slurry: 0.5% by weight of a glycol-functional siloxane prepared from 1 mole equivalent of methyltrichlorosilane and 4 mole equivalents of ethylene glycol, prepared by the same procedure as described in example 1, and 0.5% by weight of Portland cement. The gypsum had a water absorption of 7.66% by weight.
e) (not according to the invention) The following was added as an additive to the gypsum slurry: 0.4% by weight of a 50% strength emulsion in water of H-siloxane: trimethylsilyl-endcapped polymethylhydrogensiloxane mixture of the formula (CH₃)₃SiO[SiH(CH₃)O]ₓSi(CH₃)₃ where x=45 to 90. In addition to 50 parts by weight of the H-siloxane, the emulsion contained 2.5 parts by weight of a polyvinyl alcohol as an emulsifier in 47.5 parts by weight of water. The gypsum had a water absorption of 4.78%.

The examples not according to the invention show that, with products which are prepared using a stoichiometry other than that stated according to the invention, the water-repellent effect becomes substantially poorer and that the efficiency of the glycol-functional siloxanes according to the invention corresponds to that of H-siloxane.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A water-repellent gypsum composition comprising the components
(A) 100 parts by weight of gypsum
(B) 0.05-50 parts by weight of at least one oxide or hydroxide of alkali or alkaline earth metals
(C) 0.05-20 parts by weight of glycol-functional siloxane mixture, prepared by the reaction of 1 mole equivalent of alkyltrihalosilane or alkyltrialkoxysilane with at least 2.0 mole equivalents of a glycol or mixture of glycols.

2. The water-repellent gypsum composition of claim 1, wherein CaO, MgO, Ca(OH)₂, Mg(OH)₂ and NaOH or mixtures thereof are used as the oxide or hydroxide of alkali and/or alkaline earth metals.

3. The water-repellent gypsum composition of claim 1, wherein from 0.1 to 35 parts by weight of oxide and/or hydroxide, based on 100 parts by weight of gypsum, are used.

4. The water-repellent gypsum composition of claim 1, wherein the glycol-functional siloxane mixture contains silanes, oils or resins or any desired mixture thereof, comprising units of the general formula 1 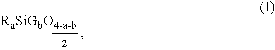
in which
R is a monovalent, optionally halogen-substituted C₁-C₁₅-hydrocarbon or hydrocarbonoxy radical or a hydroxyl group,
a is 0, 1, 2 or 3 and has a minimum value of 0.1 on average,
b is 0, 1, 2 or 3 and has a minimum value of 0.1 on average,
G is an oxygen atom, a hydroxyl radical or a monovalent or divalent branched or linear C₁-C₂₅-glycol radical, with the proviso that glycol radicals are contained in a number such that the molecule is water-soluble or self-emulsifying.

5. The water-repellent gypsum composition of claim 4, wherein the glycol-functional siloxane mixture (C) contains silanes, oils or resins or any desired mixture thereof, comprising units of the formula 1 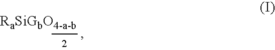
in which
R is a monovalent, optionally halogen-substituted C₁-C₁₅-hydrocarbon or hydrocarbonoxy radical or a hydroxyl groups,
a is 0, 1, 2 or 3 and has a minimum value of 0.1 on average,
b is 0, 1, 2 or 3 and has a minimum value of 0.1 on average,
G is an oxygen atom, a hydroxyl radical or a monovalent or divalent branched or linear C₁-C₂₅-glycol radical, the glycol-functional siloxanes obtained from reaction of methyltrialkoxysilane or methyltrihalosilane with a branched or linear C₁-C₂₅-glycol, with the proviso that glycol radicals are contained in a number such that the molecule is water-soluble or self-emulsifying, the stoichiometry of the reaction being chosen so that 2.0-2.99 moles of glycol are used per mole of methyltrichlorosilane or methyltrimethoxysilane.

6. The water-repellent gypsum composition of claim 1, wherein from 0.1 to 8 parts by weight of glycol-functional siloxanes, based on 100 parts by weight of gypsum, are used.

7. A process for the water-repellent treatment of gypsum, in which
(A) 100 parts by weight of gypsum are mixed with
(B) 0.05-50 parts by weight of at least one oxide or hydroxide of alkali or alkaline earth metals and
(C) 0.05-20 parts by weight of glycol-functional siloxane mixture which can be prepared by reacting 1 mole of alkyltrihalosilane or alkyltrialkoxysilane with at least 2.5 moles of a glycol or mixture of glycols.

8. The process for the water-repellent treatment of gypsum of claim 7, wherein the gypsum is made water-repellent with an aqueous or non-aqueous formulation of a glycol-functional siloxane mixture contains silanes, oils or resins or any desired mixture thereof, comprising units of the general formula 1 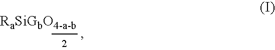
in which
R is a monovalent, optionally halogen-substituted C₁-C₁₅-hydrocarbon or hydrocarbonoxy radical or a hydroxyl group,
a is 0, 1, 2 or 3 and has a minimum value of 0.1 on average,
b is 0, 1, 2 or 3 and has a minimum value of 0.1 on average,
G is an oxygen atom, a hydroxyl radical or a monovalent or divalent branched or linear C₁-C₂₅-glycol radical, with the proviso that glycol radicals are contained in a number such that the molecule is water-soluble or self-emulsifying

9. A glycol-functional siloxane mixture prepared by reacting one mole of alkyltrihalosilane or alkyltrialkoxysilane with from 2.5 to 2.9 moles of a glycol or mixture of glycols.

10. The glycol-functional siloxane mixture of claim 9, wherein the glycol is ethylene glycol, propylene glycol, or a mixture thereof.

11. A process for the preparation of a glycol-functional siloxane mixture of claim 9, wherein one mole of an alkyltrihalosilane or alkyltrialkoxysilane is reacted with from 2.5 to 2.9 moles of a glycol or a mixture of glycols.

12. The process for the preparation of a glycol-functional siloxane mixture of claim 11, wherein the glycol is ethylene glycol, propylene glycol, or a mixture thereof.
